(19) United States
(12) Patent Application Publication
(10) Pub. No.: US 2021/0025994 A1
(43) Pub. Date: Jan. 28, 2021

(54) SIGNAL PEAK DETECTION APPARATUS AND METHOD OF SIGNAL PEAK DETECTION

(71) Applicant: Melexis Technologies NV, Tessenderlo (BE)

(72) Inventors: Sharath Patil, Ashland, MA (US); Volodymyr SELIUCHENKO, Nashua, NH (US)

(73) Assignee: Melexis Technologies NV, Tessenderlo (BE)

(21) Appl. No.: 16/523,434

(22) Filed: Jul. 26, 2019

(51) Int. Cl. G01S 7/486

(52) U.S. Cl. CPC G01S 7/4865

(57) ABSTRACT

A signal peak detection apparatus (122) comprises an analogue signal source input and a plurality of analogue temporary storage units (140) operably coupled to the analogue signal source input. Each analogue temporary storage unit is configured in successive time-window relation to a preceding analogue temporary storage unit of the plurality of analogue temporary storage units (140). A gradient direction measurement unit (146) is operably coupled to the plurality of analogue temporary storage units (140) and configured to cooperate with the plurality of analogue temporary storage units (140) to provide waveform portion-specific gradient data in an n-bit digital output format. The apparatus (122) also comprises a waveform analyser (152) comprising a bitstream state change detector (154) and an m-bit input operably coupled thereto, the m-bit input being operably coupled to the gradient direction measurement unit (146).

The present invention relates to a signal peak detection apparatus of the type that, for example, comprises a waveform analyser to identify a peak in a waveform. The present invention also relates to a method of signal peak detection, the method being of the type that, for example, receives a waveform comprising a peak and identifies the peak.

In so-called time-of-flight sensing systems and other systems, for example gaming systems, it is known to employ an illumination source to illuminate a surrounding environment within a field of view of the illumination source, sometimes known as a “scene”, and process light reflected by features of the scene. Such so-called LiDAR (Light Detection And Ranging) systems illuminate the scene with light using the illumination source, and detect light reflected from an object in the scene using a detection device, for example an array of photodiodes, some optical elements and a processing unit. Light reflected from the object in the scene is received by the detection device and converted to an electrical signal, which is then processed by the processing unit by application of a time-of-flight (ToF) calculation in order to determine the distance of the object from the detection device. Although different varieties of LiDAR system are known to be based upon different operating principles, such systems nevertheless essentially illuminate a scene and detect reflected light.

In this regard, the so-called “Flash LiDAR” technique, which is a direct ToF ranging technique, employs a light source that emits pulses of light that are subsequently reflected by features of the scene and detected by a detector device. In such a technique, the distance to a reflecting feature is calculated directly using a measured time for a pulse of light to make a round trip to the reflecting feature and back to the detector device. As such, pulse echo detection is an important function to enable accurate measurement of distance to an object. The pulses of light incident upon the detector devices are sampled in the time domain at a very high sampling rate. Usually this is achieved by means of an Analogue-to-Digital Converter (ADC) or a Time-to-Digital Converter (TDC). The signal path in the processing circuitry to implement such a technique however requires a high bandwidth for signals as well as a large silicon “real estate”, i.e. such an implementation requires a relatively large area on a silicon die, which in turn limits the number of channels that can be supported on by the die, i.e. sensor throughput can, as a consequence, be limited. The practical spatial number of channels that such Flash LiDAR sensors can support is therefore usually below 100. To overcome this limitation, mechanical scanning systems are implemented requiring moving components, which in themselves have limitations that are undesirable.

Current known techniques for echo detection in the context of Flash LiDAR involve sampling an entire incoming waveform and converting the samples to the digital domain before taking an average of several of these waveforms to eliminate noise. Echo detection algorithms are then run on the averaged waveforms to locate echoes. An example of such an approach can be found in U.S. Pat. No. 5,179,286.

According to a first aspect of the present invention, there is provided a signal peak detection apparatus comprising: an analogue signal source input; a plurality of analogue temporary storage units operably coupled to the analogue signal source input, each analogue temporary storage unit being configured in successive time-window relation to a preceding analogue temporary storage unit of the plurality of analogue temporary storage units; a gradient direction measurement unit operably coupled to the plurality of analogue temporary storage units and configured to cooperate with the plurality of analogue temporary storage units to provide waveform portion-specific gradient data in an n-bit digital output format; and a waveform analyser comprising a bitstream state change detector and an m-bit input operably coupled thereto, the m-bit input being operably coupled to the gradient direction measurement unit.

n may be unity. m may be greater than unity.

The gradient direction measurement unit may be configured to provide waveform portion-specific data in an order corresponding to increasing time. The gradient direction measurement unit may be configured to provide waveform portion-specific gradient data in an order corresponding to a time varying nature of a waveform to which the waveform portion-specific data corresponds.

The apparatus may further comprise: an analogue signal source operably coupled to the analogue signal source input and configured to provide, when in use, a waveform comprising a peak.

The bitstream state change detector may be configured to receive, when in use, gradient data via the m-bit input and to identify a change in state of first received waveform portion-specific gradient data corresponding to the peak of the waveform and a first time corresponding to the peak.

The bitstream state change detector may be configured to identify a second time corresponding to second received waveform portion-specific gradient data immediately preceding the identified change in state in the first received waveform portion-specific gradient data.

The waveform analyser may be configured to calculate a mid-point between the first and second times.

The gradient direction measurement unit may be configured to calculate a plurality of binary gradients successively in respect of a plurality of portions of the waveform.

The apparatus may further comprise: a plurality of gradient direction measurement units respectively operably coupled to the plurality of analogue temporary storage units; the plurality of gradient direction measurement units may comprise the gradient direction measurement unit.

The plurality of gradient direction measurement units may be configured to calculate a plurality of binary gradients of a respective plurality of portions of the waveform.

The gradient direction measurement unit may be configured to provide a multi-bit output.

Each of the plurality of gradient direction measurement units may be configured to provide a multi-bit output.

The multi-bit output may be a two-bit output. The multi-bit output may be a three-bit output.

The gradient direction measurement unit may be a comparator operably coupled to the plurality of analogue temporary storage units. The plurality of gradient direction measurement units may be a bank of comparators operably coupled to the plurality of analogue temporary storage units and may comprise a respective plurality of outputs.

The apparatus may further comprise: a summation unit operably coupled to the gradient direction measurement unit; and the summation unit may be configured to sum signals received, when in use, from the gradient direction measurement unit.

The apparatus may comprise a plurality of gradient direction measurement units comprising the gradient direction measurement unit. The plurality of gradient measurement units may comprise a respective plurality of outputs. The apparatus may comprise a plurality of summation units comprising a respective plurality of inputs. The plurality of inputs of the plurality of summation units may be respectively operably coupled to the plurality of outputs of the plurality of gradient direction measurement units. The plurality of summation units may be configured to sum respectively signals received, when in use, via each output of the plurality of outputs of the plurality of gradient direction measurement units.

The waveform analyser may be configured to cooperate with the summation unit in order to analyse in a bitwise manner sum signals generated by the summation unit.

The waveform analyser may be configured to cooperate with the plurality of summation units in order to analyse in a bitwise manner sum signals generated by the plurality of summation units in order to identify a state change.

The plurality of analogue temporary storage units may be a bank of sample and hold cells.

The apparatus may further comprise: a current-to-voltage conversion unit having an input operably coupled to the analogue signal source input, and an output operably coupled to the plurality of analogue temporary storage units.

The current-to-voltage conversion unit may be a transimpedance amplifier.

The waveform analyser may further comprises: a filter unit operably coupled between the m-bit input of the waveform analyser and the bit stream state change detector.

According to a second aspect of the invention, there is provided a distance measurement apparatus comprising: a distance calculation unit operably coupled to a signal peak detection apparatus as set forth above in relation to the first aspect of the invention; wherein the distance calculation unit may be configured to calculate a distance using the first time.

According to a third aspect of the invention, there is provided a method of signal peak detection, the method comprising: receiving an analogue waveform comprising a peak; determining a plurality of gradient directions in respect of successive portions of the waveform, thereby providing a plurality of gradient directions; arranging the plurality of gradient directions in time order; and analysing the plurality of gradient directions and identifying a change in state in the plurality of gradient directions.

It is thus possible to provide a signal peak detection apparatus and a method of signal peak detection that eliminates the necessity of a multi-bit ADC in a signal processing chain for the purpose of detecting an optional echo, thereby increasing the throughput of the signal peak detection apparatus as compared with signal processing chains comprising multi-bit ADCs. As such, it is possible to provide high resolution, high-speed, Flash LiDAR sensors. In this regard, Flash LiDAR sensors employing the method and apparatus can benefit from being smaller and lower cost than other kinds of LiDAR sensors, for example mechanically scanning LiDAR sensors. The apparatus and method also simplify implementation of Flash LiDAR sensors.

At least one embodiment of the invention will now be described, by way of example only, with reference to the accompanying drawings, in which:

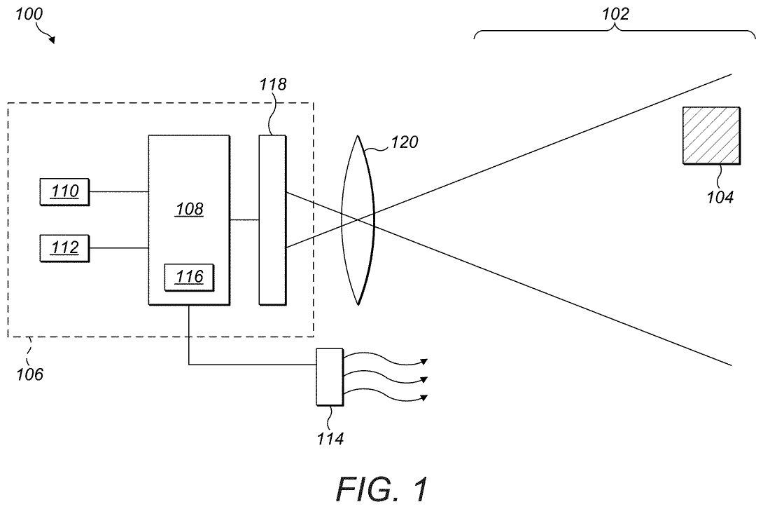

FIG. 1 is a schematic diagram of a pulsed-light detection and ranging apparatus constituting an embodiment of the invention;

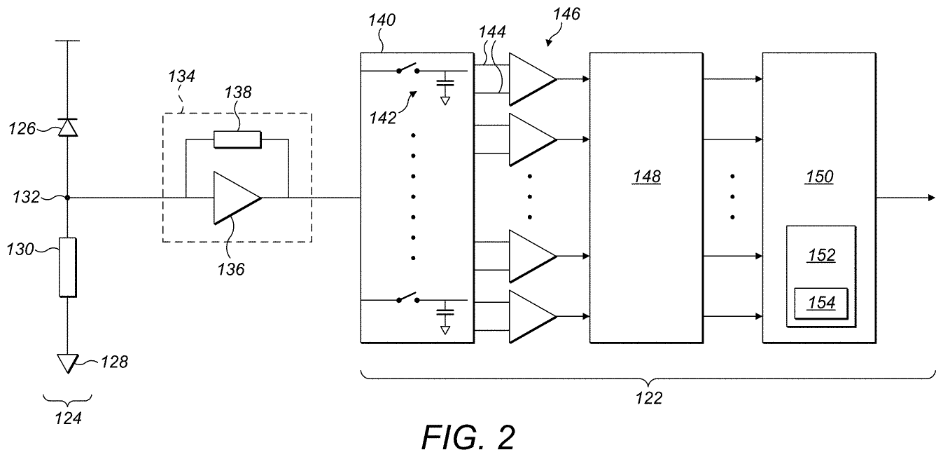

FIG. 2 is a schematic diagram of a photodetector module and a signal peak detector apparatus of the apparatus in FIG. 1 in greater detail;

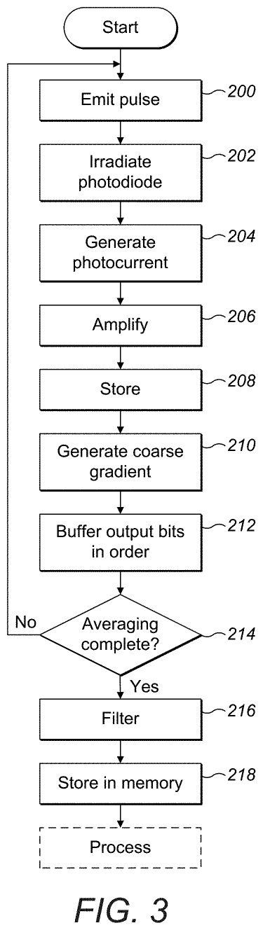

FIG. 3 is a flow diagram of a first part of a method of detecting a signal peak constituting another embodiment of the invention;

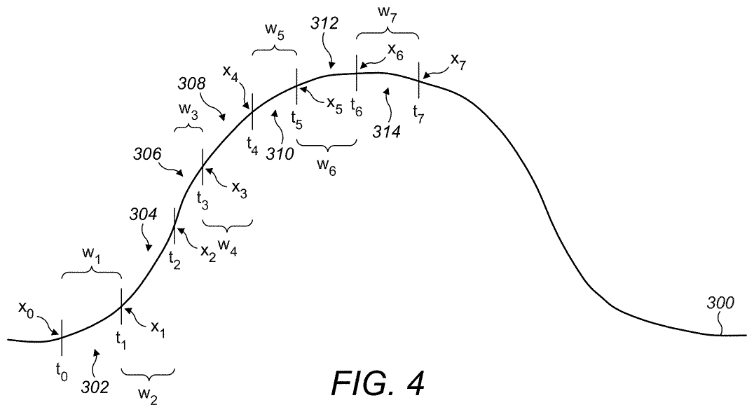

FIG. 4 is a schematic diagram of a part of a waveform comprising a peak;

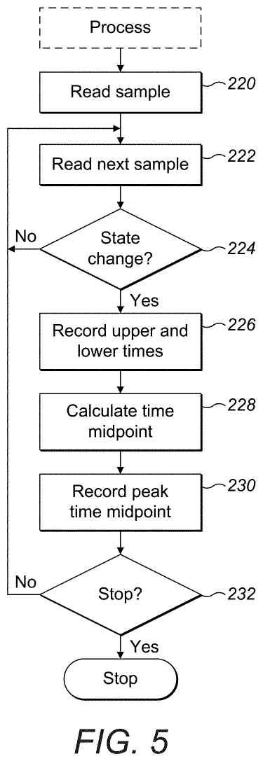

FIG. 5 is a flow diagram of a second part of the method of detecting a signal peak of FIG. 3;

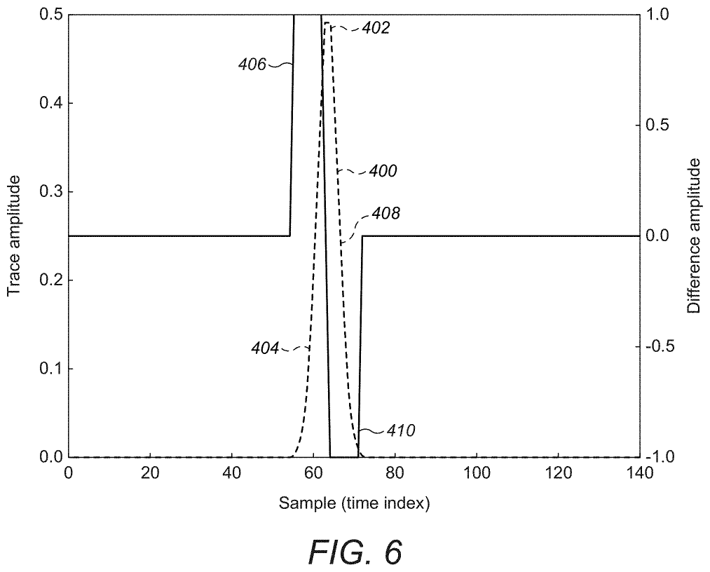

FIG. 6 is a plot of an output of the signal peak detector apparatus of FIG. 2 overlaid with the waveform causing the output of the signal peak detector apparatus;

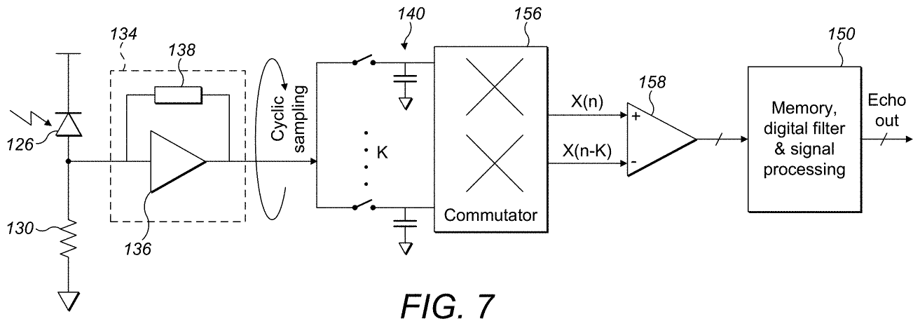

FIG. 7 is a schematic diagram an alternative configuration of the photodetector module and signal peak detector apparatus of FIG. 2 constituting a further embodiment of the invention; and

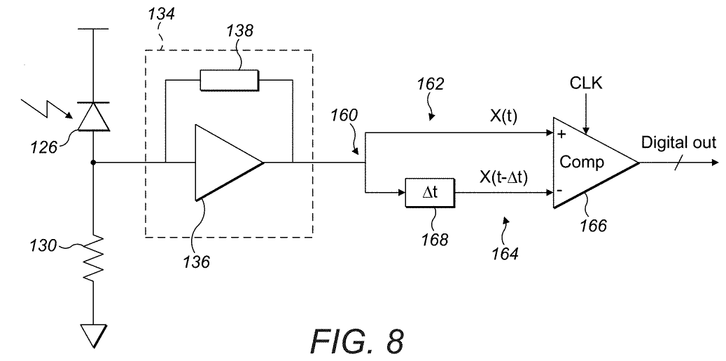

FIG. 8 is a schematic diagram of a part of the photodetector module and signal peak detector apparatus of FIG. 2 constituting yet another embodiment of the invention.

Throughout the following description, identical reference numerals will be used to identify like parts.

Referring to FIG. 1, a pulsed-light detection and ranging apparatus 100 is, for example, disposed within an environment to monitor a so-called scene 102. A typical application for the apparatus 100 is in a LiDAR system. The scene 102 comprises a reflective object 104.

The pulsed-light detection and ranging apparatus 100 comprises a detection and ranging circuit 106 comprising a processing resource, for example a signal processor 108 operably coupled to a non-volatile memory, for example a Read Only Memory (ROM) 110 and a volatile memory, for example a Random Access Memory (RAM) 112. The signal processor 108 can be disposed on a first die. An illumination source, for example a pulsed optical or light source 114, such as a pulsed-laser, is operably coupled to the signal processor 108, the signal processor 108 supporting a synchronisation unit 116. The signal peak detector apparatus 122 is also operably coupled to the synchronisation unit 116 so that the time of emission is known. The signal processor 108 is also operably coupled to an optical detection device, for example photodetector module 118. In this example, the photodetector module 118 is provided on a second die. An optical system comprising, for example a lens 120, such as a focussing lens, can also be provided adjacent the photodetector module 118 of the pulsed-light detection and ranging apparatus 100.

Referring to FIG. 2, the signal processor 108 of the pulsed-light detection and ranging apparatus 100 supports a signal peak detector apparatus 122 and the photodetector module 118, and in this example, the latter separately comprises a plurality of photodetector cells 124 and the associated transimpedance amplifiers 134. The photodetector module 118 provides a plurality of photodetector cells, for example an array of photodetector cells. However, for the sake of clarity and conciseness of description only a single photodetector cell 124, a single transimpedance amplifier 134 and a single signal peak detector apparatus 122 are shown and mostly described herein.

Furthermore, it should be noted that although, in this example, the signal peak detector apparatus 122 is being described in the context of LiDAR, the signal peak detector apparatus 122 finds application in other fields of endeavour, for example ultrasound scanning.

In this example, the photodetector cell 124 comprises a photodiode 126 having an anode operably coupled to ground potential 128 via a first resistance 130. An output terminal 132 between the anode of the photodiode 126 and a terminal of the first resistance 130, which is coupled to the anode of the photodiode 126, is operably coupled to an input of a transimpedance amplifier 134, the transimpedance amplifier 134 comprising an operational amplifier 136 coupled in parallel with a second resistance 138 across an input terminal of the operational amplifier 136 and an output terminal of the operational amplifier 136. An output of the transimpedance amplifier 136 constitutes an analogue signal source input for the signal peak detector apparatus 122, and is operably coupled to a bank of sample and hold circuits 140 comprising a plurality of sample and hold circuits 142 which constitutes a plurality of analogue temporary storage units. Each of the plurality of sample and hold circuits 142 is arranged in successive time-window relation to a preceding sample and hold circuit as will be described in greater detail later herein. The bank of sample and hold circuits 140 comprises a plurality of outputs corresponding respectively to the plurality of sample and hold circuits 142.

The plurality of outputs is organised successively to provide samples of an analogue input waveform received from the transimpedance amplifier 134 in time-delayed relation. The output of the transimpedance amplifier 134 constitutes, in this example, an analogue signal source and the coupling between the transimpedance amplifier 134 and the bank of sample and hold circuits constitutes an analogue signal source input.

Consequently, a first output provides a first sample in respect of the first time, t₀, a second output provides a second sample in respect of a second time, t₁, a third output provides a third sample in respect of a third time, t₂, a fourth output provides a fourth sample in respect of a fourth time, t₃, a fifth output provides a fifth sample in respect of a fifth time, t₄, a sixth output provides a sixth sample in respect of a sixth time, t₅, a seventh output provides a seventh sample in respect of a seventh time, t₆, an eighth output provides an eighth sample in respect of a eighth time, t₇, etc. The bank of sample and hold circuits 140 therefore provides a plurality of outputs that are operably coupled successively to inputs of a plurality of comparators 146 so that with the exception of the first and last outputs of the plurality of outputs, each output is operably coupled to a second input of one comparator and a first input of a temporally successive comparator, thereby coupling the plurality of comparators 146 so as to provide comparison outputs in respect of temporally contiguous portions of the input waveform as will be described in greater detail later herein. However, in other embodiments, instead of being consecutive or successive, the plurality of outputs of the bank of sample and hold circuits 140 can be operably coupled to temporally subsequent inputs of the plurality of comparators 146. Each comparator constitutes a gradient direction measurement unit. An output of each of the plurality of comparators 146 is operably coupled to a respective plurality of inputs of a bit combiner unit 148, constituting a summation unit that sums and, in this example, averages received signals, and having, in this example, a plurality of summed outputs operably coupled to a processing resource 150 comprising, for example a memory and a waveform analyser 152 having an m-bit input and a bitstream state change detector 154. In this example, the m-bit input is operably coupled to the plurality of comparators 146 via the bit combiner circuit 148. The waveform analyser 152, in this example, also comprises a filter unit (not shown). In examples where averaging and/or summation is not implemented, the m-bit input can be configured to support a number of bits of a format of waveform portion-specific gradient data generated by the plurality of comparators 146, for example the same number of bits. However, where averaging and/or summation is employed, m is greater than the number of bits of the format of the waveform portion-specific gradient data generated.

In operation (FIGS. 2, 3 and 4), the signal peak detector apparatus 122 is described in respect of eight sample and hold circuits of the plurality of sample and hold circuit 140 in order to illustrate the ability of the signal peak detector apparatus 122 to detect a peak in the input waveform. Since, in this example, the signal peak detector apparatus 122 is part of a Flash LiDAR system, the source of electromagnetic radiation 114 emits (Step 200) pulses of light in response to a trigger signal received from the synchronisation unit 116.

Once a pulse of light has been emitted by the source of electromagnetic radiation 114, the light emitted is, in this example, reflected by the reflective object 104 in the scene 102 and returns to the photodiode 126 via the lens 120 and irradiates (Step 202) the photodiode 126. Of course, in the context of the photodetector module 118, many photodetectors (not shown) are irradiated. In response to irradiation by the reflected light, the photodiode 126 generates (Step 204) a photocurrent, which is subsequently amplified and converted to a voltage (Step 206) by the transimpedance amplifier 134.

Thereafter, the voltages output by the transimpedance amplifier 134 are stored (Step 208) by the bank of sample and hold circuits 140. In this regard, and as described above, the plurality of sample and hold circuits 142 are arranged in time-delayed relation to each other, namely each sample and hold circuit of the plurality of sample and hold circuits 140 is arranged to sample and hold different portions of the waveform output by the transimpedance amplifier 134. Each portion is, for example, contiguous with a preceding portion. As such the plurality of sample and hold circuits 142 store sequential portions of the waveform. Referring to FIG. 4, expressed differently, the waveform 300 can be notionally divided up into contiguous time window portions, for example a first waveform portion 302 can be in respect of a first time window, w₁, bounded by the first and second times, t₀, t₁, a second waveform portion 304 can be in respect of a second time window, w₂, bounded by the second and third times, t₁, t₂, which follows the first time window, w₁, in time. Likewise, a third waveform portion 306 can be in respect of a third time window, w₃, bounded by the third and fourth times, t₂, t₃, a fourth waveform portion 308 can be in respect of a fourth time window, w₄, bounded by the fourth and fifth times, t₃, t₄, a fifth waveform portion 310 can be in respect of a fifth time window, w₅, bounded by the fifth and sixth times, t₄, t₅, a sixth waveform portion 312 can be in respect of a sixth time window, w₆, bounded by the sixth and seventh times, t₅, t₆, and a seventh waveform portion 314 can be in respect of a seventh time window, w₇ bounded by the seventh and eighth times, t₆, t₇. Of course, the waveform 300 can comprise further portions in respect of further time windows, but for the sake of clarity and simplicity of description only seven waveform portions and seven respective time windows will be described, since it is unnecessary to describe further waveform portions in order to exemplify embodiments. In some examples, the bank of sample and hold circuits 140 can comprise a limited number of sample and hold circuits, which can be cycled in a manner to be described later herein.

As explained above, each sample stored by each respective sample and hold circuit, which bounds a waveform portion, is time sequential, although it should be appreciated that the plurality of sample and hold circuits can be arranged so that the outputs are selected in a time sequential manner but not topologically arranged as such. In any event, in this example, the signal sampled and held by each of the plurality of sample and hold circuits 142 is applied in successive pairs in time order respectively to the pairs of inputs of the plurality of comparators of the plurality of comparators 146. As such, in this example, the plurality of comparators 146 is configured to provide gradient direction data in an order corresponding to increasing time, which in this example is the order corresponding to the time varying nature of the input waveform.

Referring back to the waveform portions of the input waveform 300 of FIG. 4, a first sample and hold circuit outputs a first output signal, x₀, in respect of the first time, t₀, and a second sample and hold circuit outputs a second output signal, x₁, in respect of the second time, t₁. Likewise, a third sample and hold circuit outputs a third output signal, x₂, in respect of the third time, t₂, a fourth sample and hold circuit outputs a fourth output signal, x₃, in respect of the fourth time, t₃, a fifth sample and hold circuit outputs a fifth output signal, x₄, in respect of the fifth time, t₄, a sixth sample and hold circuit outputs a sixth output signal, x₅, in respect of the sixth time, t₅, and a seventh sample and hold circuit outputs a seventh output signal, x₆, in respect of the seventh time, t₆, and an eighth sample and hold circuit outputs an eighth output signal, x₇, in respect of the eighth time, t₇. In this example, the first output signal, x₀, is provided to a first input of a first comparator and the second output signal, x₁, is provided to a second input of the first comparator and a first input of a second comparator. The third output signal, x₂, is provided to a second input of the second comparator and a first input of a third comparator. The fourth output signal, x₃, is provided to a second input of the third comparator and a first input of a fourth comparator. The fifth output signal, x₄, is provided to a second input of the fourth comparator and a first input of a fifth comparator. The sixth output signal, x₅, is provided to a second input of the fifth comparator and a first input of a sixth comparator. The seventh output signal, x₆, is provided to a second input of the sixth comparator and a first input of a seventh comparator, and the eighth output signal, x₇, is provided to a second input of the seventh comparator and a first input of an eighth comparator. Additionally or alternatively, in some embodiments (not shown), the first and last outputs of the bank of sample and hold circuits 140 can be coupled to first and second inputs of a comparator of the plurality of comparators 146 to provide and additional guide as to the overall trend of the input waveform 300. It should, however, be appreciated that this configuration is merely an example and other pairs of outputs of the bank of sample and hold circuits 140 can be coupled to inputs of a given comparator, as already suggested above.

The comparators of the plurality of comparators 146 each generate (Step 210) a gradient direction indication based upon a difference between two input signals thereof and thus cooperate with the plurality of sample and hold circuits to provide waveform portion-specific gradient data in an n-bit digital output format. In this example, the output is a single bit indicative of an increase or decrease in gradient. The indications of the gradients are coarse, but adequate for the purpose they are to serve. However, as will be described later herein, in other embodiments comparators can be employed that provide greater resolution to the indication of gradient direction without attracting an undesirably large overhead in terms of die space use. The first comparator therefore provides a first gradient direction output signal in respect of the first waveform portion 302. The second comparator provides a second gradient direction output signal in respect of the second waveform portion 304. The third comparator provides a third gradient direction output signal in respect of the third waveform portion 306. The fourth comparator provides a fourth gradient direction output signal in respect of the fourth waveform portion 308. The fifth comparator provides a fifth gradient direction output signal in respect of the fifth waveform portion 310. The sixth comparator provides a sixth gradient direction output signal in respect of the sixth waveform portion 312. The seventh comparator provides a seventh gradient direction output signal in respect of the seventh waveform portion 314.

The first, second, third, fourth, fifth, sixth and seventh gradient direction output signals are then buffered (Step 212) temporarily and averaged with subsequent outputs of the plurality of comparators 146 by the bit combiner unit 148 in order to optimise signal-to-noise ratio. Once a sufficient number of outputs of the plurality of comparators 146 has been averaged (Step 214), the temporarily buffered output signals are low-pass filtered (Step 216) by the filter unit mentioned above before being stored (Step 218) by the bit combiner unit 148 either in time order or so as to be accessible in time order.

Thereafter (FIG. 5), as described above, the stored digital outputs stored by the bit combiner unit 148 are either read out (Step 220, 222) in time order or provided in time order to the processing resource 150. The first sample, for example the first averaged gradient direction output, is read out (Step 220) of memory and then the second sample, for example the second averaged gradient direction output, is also read out (Step 222) of the memory. The bitstream state change detector 154 of the waveform analyser 152 analyses in, for example a bitwise manner, the first and second averaged gradient direction outputs in order to determine (Step 224) whether the state of the second averaged gradient direction output has changed with respect to the first averaged gradient direction output. In the event that a state change has been detected, an upper time boundary of the waveform portion responsible for the change in state and a lower time boundary of the waveform portion in respect of an immediately preceding gradient direction value are recorded. In the context of the waveform 300 of FIG. 4, and assuming approximately consistent results during the repeated generation of the coarse gradient directions by the comparators for averaging purposes, the first and second comparators both output like binary values indicative of temporally successive gradient increases, for example successive logic 1 values. As such, no change of state is detected (Step 224) and a subsequent averaged gradient direction output is read out (Step 222) from the bit combiner unit 148 and the state of the subsequently averaged gradient direction output is compared with the immediately preceding averaged gradient direction to determine if a change in state has occurred. Again, in respect of the third waveform portion, no change in gradient has occurred. The above process continues until a change of state is detected. In this respect, following the averaged gradient direction output in respect of the sixth waveform portion 312, the averaged gradient direction output in respect of the seventh waveform portion 314 is analysed and the state change of the coarse gradient is determined to have changed, for example to a logic 0. This can also be seen with the assistance of the example waveform 400 of FIG. 6, where the waveform 400 comprises a steeper peak 402, a rising portion 404 of the waveform 400 leading to the peak 402 results in the a comparator of the plurality of comparators 146 determining the gradient direction of the rising portion 404 contributing to the generation of an averaged gradient direction signal that is a positive, in this example binary, output signal 406, and another comparator of the plurality of comparators 146 determining the gradient direction of a subsequent, predominantly falling, portion 408 of the waveform 400 contributes to the generation of an averaged negative, in this example binary, output signal 410.

Referring back to the waveform 300 of FIG. 4, the processing resource 150 consequently records (Step 226) the upper time boundary in respect of the seventh waveform portion 314 where the state change occurred and the lower time boundary in respect of the preceding state of the averaged gradient direction output, namely t₇, and t₅. Using the two times recorded, the processing resource then calculates (Step 228) a mid-point of the two times, t₅, t₇, and the mid-point time calculated is stored (Step 230). The signal peak detection apparatus 122 then determines whether detection of peaks in the waveform generated by the photodetector cell 124 is to continue or stop, for example in the event that the pulsed-light detection and ranging apparatus 100 is being powered down.

The time data determined can then be used to calculate a distance to the reflective object 104. In the above example, the mid-point time calculated can be employed to calculate the distance by a distance calculation unit (not shown) that can access the mid-point time and calculate the distance based upon the knowledge of the speed of light and the time of emission of a pulse of light emitted by the source of electromagnetic radiation 114 that is reflected by the reflective object 104. In some embodiments, the mid-point time calculated is not used and a time at which a change of state of gradient is detected is used to calculate the distance to the object.

The skilled person should appreciate that the above-described implementations are merely examples of the various implementations that are conceivable within the scope of the appended claims. Indeed, it should be appreciated that, for example, analysis of the averaged gradient directions can be enhanced to handle detection in respect of non-symmetric received pulses, for example when the light source 114 emits non-symmetric pulses of light. In order to enhance accuracy of peak detection, the magnitude of gradients can be analysed in order to determine a side of the calculated mid-point where a peak occurs. Therefore, although in the above examples, the plurality of comparators is arranged to provide single bit outputs each, in another embodiment, the comparators are arranged each to provide multi-bit outputs, for example two-bit outputs, which can employ a two's complement scheme to represent four values: two positive and two negative. In such an embodiment, the values output are averaged in a like manner to that already described above, but in the context of multi-bit values, and an indication of magnitude of a gradient, albeit coarse, can be provided. In such an example, a direction of a given gradient can be indicated by a Most Significant Bit (MSB) of the gradient value output by a comparator enhanced in the above-described manner. In one implementation, a voltage subtractor circuit comprising, for example an operational amplifier, can be coupled in series to a voltage adder comprising, for example an operational amplifier, the output of the voltage adder being operably coupled to a two-bit analogue-to-digital converter to provide a multi-bit value output. The voltage subtractor provides the difference between two inputs, for example waveform portion boundaries and the voltage adder introduces a bias voltage or level shift in order to provide the analogue-to-digital converter with positive voltage values to convert to the digital domain. In this regard, the output of the two-bit comparator is in a format where for example the MSB corresponds to the sign of the gradient calculated and the Least Significant Bit provides an indication of the quantum of the gradient, for example: less than 25 mV or 0 to 25 mV. Combined with the sign provided by the MSB, values of less than −25 mV, −25 mV to 0V, 0V to 25 mV and greater than 25 mV can be output. However, in other embodiments, the two-bit output comparator can be configured, if desired, to provide the indication of gradient in a two's complement format. Of course, in other embodiments, the multi-bit output can be greater than two, for example three, provided the benefit of using fewer processing channels than conventional ADC processing is not lost.

In the examples set forth herein, the plurality of comparators 146 is employed to analyse different portions of the input waveform. However, in another embodiment a fewer number of comparators or a single comparator can be employed in order to calculate a plurality of gradient direction data, for example serially.

In another embodiment, where the bank of sample and hold circuits 140 comprises a limited number of sample and hold circuits 142, the sample and hold circuits 142 can be cycled as mentioned above to store samples of the waveform 300, thereby enabling sampling and comparison across, for example, substantially the entirety of the waveform 300. Referring to FIG. 7, the transimpedance amplifier 134 is operably coupled to the bank of sample and hold circuits 140, the bank of sample and hold circuits 140 comprising a controller (not shown) to control cyclic connection of sample and hold circuits 142 of the bank of sample and hold circuits 140 to an input of the bank of sample and hold circuits 140, for example in a switched manner. The sample and hold circuits 142 are coupled to the output of the transimpedance amplifier 134 in a temporally cycling manner so that a time difference, Δt, exists between a sample and hold circuit coupled to the output of the transimpedance amplifier 134 and a sample and hold circuit immediately previously coupled to the output of the transimpedance amplifier 134.

A commutator 156 comprises a plurality of inputs, the plurality of inputs being operably coupled to outputs of the plurality of sample and hold circuits 142, respectively. The commutator 156 is configured to select pairs of sample and hold circuits 142 for comparison in accordance with the methodology set forth herein. The commutator 156 also comprises a first output and a second output operably coupled to a first input and a second input, respectively, of a comparator 158 in order to provide a sampled signals output by selected pairs of sample and hold circuits 142. An output of the comparator 158 is operably coupled to the processing resource 150 in a like manner to that described above in relation to previous examples.

In the above examples, sample and hold circuits 142 are employed to provide time spaced samples of the waveform 300 for comparison. However, it should be appreciated that, more generally, the above examples compare time-spaced measurements of the waveform 300 in order to determine gradient directions of a respective portion of the waveform 300 bounded by the time-spaced measurements. This can be illustrated with reference to FIG. 8, where portions of the output of the transimpedance amplifier 134 can be compared, which can be achieved by creating multiple instances 160 of the waveform 300 output by the transimpedance amplifier 134 resulting in, for example, a first signal branch 162 and a second signal branch 164. The first signal branch 162 is provided at a first input of a comparator 166, and the second signal branch 164 is provided at a second input of the comparator 166 via a delay 168. The delay 168 is, in this example, an analogue delay, such as a unity gain amplifier or the like. An output of the comparator 166 is operably coupled to the processing resource 150 in a like manner to that already described above in relation to other implementations. In operation, the comparator 166 provides a continuous output of gradient directions, which is then sampled (indicated by CLK-signal) by the processing resource 150 to obtain digital gradient direction data.

It should be appreciated that the use of programmable elements set forth herein are purely exemplary and the skilled person will appreciate that programmable elements can be replaced with a “hard wired” implementation, for example a circuit employing digital logic.

It should be appreciated that references herein to “light”, other than where expressly stated otherwise, are intended as references relating to the optical range of the electromagnetic spectrum, for example, between about 350 nm and about 2000 nm, such as between about 550 nm and about 1550 nm or between about 600 nm and about 1000 nm.

Use herein of specific functional units should be understood as being exemplary only and the skilled person will appreciate that such functionality can be provided in different functional units and/or distributed over a number of functional units.

Alternative embodiments of the invention can be implemented as a computer program product for use with a computer system, the computer program product being, for example, a series of computer instructions stored on a tangible data recording medium, such as a diskette, CD-ROM, ROM, digital memory or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

What is claimed is:

1. A signal peak detection apparatus comprising:
an analogue signal source input;
a plurality of analogue temporary storage units operably coupled to the analogue signal source input, each analogue temporary storage unit being configured in successive time-window relation to a preceding analogue temporary storage unit of the plurality of analogue temporary storage units;
a gradient direction measurement unit operably coupled to the plurality of analogue temporary storage units and configured to cooperate with the plurality of analogue temporary storage units to provide waveform portion-specific gradient data in an n-bit digital output format; and
a waveform analyser comprising a bitstream state change detector and an m-bit input operably coupled thereto, the m-bit input being operably coupled to the gradient direction measurement unit.

2. The apparatus according to claim 1, further comprising:
an analogue signal source operably coupled to the analogue signal source input and configured to provide, when in use, a waveform comprising a peak.

3. The apparatus according to claim 2, wherein the bitstream state change detector is configured to receive, when in use, gradient data via the m-bit input and to identify a change in state of first received waveform portion-specific gradient data corresponding to the peak of the waveform and a first time corresponding to the peak.

4. The apparatus according to claim 3, wherein the bitstream state change detector is configured to identify a second time corresponding to second received waveform portion-specific gradient data immediately preceding the identified change in state in the first received waveform portion-specific gradient data.

5. The apparatus according to claim 4, wherein the waveform analyser is configured to calculate a mid-point between the first and second times.

6. The apparatus according to claim 2, wherein the gradient direction measurement unit is configured to calculate a plurality of binary gradients successively in respect of a plurality of portions of the waveform.

7. The apparatus according to claim 2, further comprising:
a plurality of gradient direction measurement units respectively operably coupled to the plurality of analogue temporary storage units, the plurality of gradient direction measurement units comprising the gradient direction measurement unit.

8. The apparatus according to claim 7, wherein the plurality of gradient direction measurement units is configured to calculate a plurality of binary gradients of a respective plurality of portions of the waveform.

9. The apparatus as claimed according to claim 2, wherein the gradient direction measurement unit is configured to provide a multi-bit output.

10. The apparatus as claimed in claim 7, wherein each of the plurality of gradient direction measurement units is configured to provide a multi-bit output.

11. The apparatus according to claim 1, further comprising:
a summation unit operably coupled to the gradient direction measurement unit; and
the summation unit is configured to sum signals received, when in use, from the gradient direction measurement unit.

12. The apparatus according to claim 1, further comprising:
a current-to-voltage conversion unit having an input operably coupled to the analogue signal source input, and an output operably coupled to the plurality of analogue temporary storage units.

13. The apparatus according to claim 1, wherein the waveform analyser further comprises:
a filter unit operably coupled between the m-bit input of the waveform analyser and the bit stream state change detector.

14. A distance measurement apparatus comprising:
a distance calculation unit operably coupled to a signal peak detection apparatus according to claim 3; wherein
the distance calculation unit is configured to calculate a distance using the first time.

15. A method of signal peak detection, the method comprising:
receiving an analogue waveform comprising a peak;
determining a plurality of gradient directions in respect of successive portions of the waveform, thereby providing a plurality of gradient directions;
arranging the plurality of gradient directions in time order; and
analysing the plurality of gradient directions and identifying a change in state in the plurality of gradient directions.
